(19) United States
(12) Patent Application Publication
(10) Pub. No.: US 2024/0413969 A1
(43) Pub. Date: Dec. 12, 2024

(54) SYSTEM AND PROCESS FOR SECURING CLIENT DATA DURING FEDERATED LEARNING

(71) Applicant: Leidos, Inc., Reston, VA (US)

(72) Inventors: Olivia Galliker d'Aliberti, Washington, DC, DC (US); Evan Michael Gronberg, Riverside, CA (US)

(73) Assignee: Leidos, Inc., Reston, VA (US)

(21) Appl. No.: 18/740,780

(22) Filed: Jun. 12, 2024

Related U.S. Application Data
(60) Provisional application No. 63/507,615, filed on Jun. 12, 2023.

(51) Int. Cl. H04L 9/00; H04L 9/08

(52) U.S. Cl. CPC H04L 9/008; H04L 9/0819

(57) ABSTRACT

In a federated learning system, a central server and multiple individual clients utilize model segmentation (CMS), wherein instead of each client sending its full model, the server only requests certain parameter matrices from each client model; and fully homomorphic encryption (FHE), wherein the certain parameter matrices are homomorphically encrypted before being sent to the server. FHE enables computations to be run on encrypted data, so the server is still able to aggregate received encrypted matrices.

### CROSS-REFERENCE TO RELATED APPLICATIONS

The present application claims the benefit of priority to U.S. Provisional Patent Application No. 63/507,615 entitled A PROCESS FOR SECURING CLIENT DATA DURING FEDERATED LEARNING, filed Jun. 12, 2023, which is incorporated herein by reference in its entirety.

### COMPUTER PROGRAM LISTING

An Appendix hereto includes the following computer program listing which is incorporated herein by reference: “LEID0046US_BlindFLCodeAppendix.txt” created on Jun. 10, 2024, 63.1 KB.

### BACKGROUND

### Technical Field

The technical field is generally related to protecting client data privacy in a federated learning system and more specifically to combining client model segmentation (CMS) and fully homomorphic encryption (FHE) to achieve this goal.

### Description of Related Art

Internet of Things (IoT) devices, sensor systems, and other edge computing devices, are light-weight, low-latency platforms that include the ability to collect and respond to data quickly. Products that rely upon data collected by these systems have the potential to be enhanced by artificial intelligence (AI). AI models allow computers to process, analyze, and respond to data by detecting patterns and making predictions in a way that mirrors human responses. To develop predictive ability, AI model construction conventionally relies upon the collection of data in a single location. This presents privacy concerns since the centralization of data could result in the potential misuse of sensitive information such as personally identifiable information (PII).

Federated learning (FL) has been popularized as a way to collaboratively train a shared AI model while keeping training data at the edge, thus separating the ability to train AI from the need for a centralized data set. Instead of gathering all data in a centralized location, FL typically relies upon edge nodes passing their locally updated model parameters to a central server. The central server, who coordinates this process, then aggregates the parameters from each local model to update its global model. Finally, the centralized model parameters are sent to edge nodes to be further updated. In following this procedure, FL allows edge-to-cloud models to avoid sharing data for model training. Today, AI models are increasingly deployed and updated on edge devices using FL architectures for services like text completion, self-driving cars, healthcare services, and other domains where one or more of the following characteristics is present: data is collected at the edge from user devices; there is limited bandwidth to transmit user data to the cloud; predictions at the edge are made using a local model and locally collected data; and predictions are specific to given users (i.e., they may differ from the predictions made for other users).

Standard FL architecture also offers privacy benefits, since user data does not need to leave the edge device and only a local model, trained with the user's data, is passed from client to server. However, sharing models rather than data does not guarantee privacy, since sharing models still risks the potential for privacy leakage, in particular risks from model inversion attacks. During a model inversion attack, a malicious actor attempts to reconstruct the model's original training set with access to only the model. Several model inversion attacks, particularly those using generative adversarial networks (GANs), have been shown to be quite effective at reconstructing training data from AI models.

To protect against model inversion attacks (and other server-side privacy risks), several secure aggregation procedures have emerged. These proposed procedures work to counter data leakages through various privacy-preserving mechanisms, including cryptographic techniques, perturbative techniques, and anonymization techniques, which all belong to the larger class of privacy-preserving federated learning (PPFL) protocols. These protocols have typically fallen short in their impact on model accuracy, particularly in approaches that use differential privacy, or in their impact on system performance, particularly in approaches that use fully homomorphic encryption (FHE).

The seminal work describing PPFL implementations in PyTorch was written by Ryffel, et al., A generic framework for privacy preserving deep learning. CoRR abs/1811.04017 (2018), arXiv: 1811.04017. As FL implementations grew in popularity, so did the number of attacks proposed upon FL edge-to-cloud systems. Inferencing attacks resulting in information leakages was first proposed by Hitaj, et al., Deep Models Under the GAN: Information Leakage from Collaborative Deep Learning, In Proceedings of the 2017 ACMSIGSAC Conference on Computer and Communications Security (Dallas, Texas, USA) (CCS ′17). Further notable works include gradient attacks mentioned in Wang, et al., Towards Eliminating Hard Label Constraints in Gradient Inversion Attacks, arXiv: 2402.03124v2 [cs.CR] 15 Apr. 2024, and He et al., Model inversion attacks against collaborative inference, In Proceedings of the 35th Annual Computer Security Applications Conference (San Juan, Puerto Rico, USA) (ACSAC ′19). A full survey of gradient attacks is covered under Huang, et al., Evaluating Gradient Inversion Attacks and Defenses in Federated Learning, arXiv: 2112.00059v1 [cs.CR] 30 Nov. 2021.

A variety of counter measures to defend against attacks to FL systems has also emerged. In 2019, Zhu, et al. proposed gradient pruning as a method to obscure model gradients without any changes in training. See Zhu, et al., Deep Leakage from Gradients, arXiv: 1906.08935v2 [cs.LG] 19 Dec. 2019. In 2020, Huang, et al. proposed InstaHide, “[encrypting] each training image with a ‘one-time secret key.’” See Huang et al., InstaHide: Instance-hiding Schemes for Private Distributed Learning, arXiv: 2010.02772v2 [cs.CR] 24 Feb. 2021. And Hu, et al. worked on decentralized FL with a segmented gossip approach, as described in Decentralized Federated Learning: A Segmented Gossip Approach, arXiv: 1908.07782v1 [cs.LG] 21 Aug. 2019.

In 2018, Phong, et al. used homomorphic encryption to protect deep learning model gradients as described in Privacy-Preserving Deep Learning via Additively Homomorphic Encryption. IEEE Transactions on Information Forensics and Security 13, 5 (2018), 1333-1345. Yin, et al. in 2021 produced a review of emerging PPFL techniques and notes the decrease in accuracy for several approaches. See Yin, et al., A Comprehensive Survey of Privacy-preserving Federated Learning: A Taxonomy, Review, and Future Directions. ACM Comput. Surv. 54, 6, Article 131 (July 2021), 36 pages. In 2023, Rahulamathavan, et al. worked on the FheFL PPFL, applying FHE directly to FL model gradients as described in FheFL: Fully Homomorphic Encryption Friendly Privacy-Preserving Federated Learning with Byzantine Users, arXiv: 2306.05112v2 [cs.AI] 26 Jun. 2023. Rahulamathavan, et al. notes the increased bandwidth requirements that the use of FHE introduces. And in 2023, Jin, et al. proposed FedML-HE, an approach that selectively encrypts only the most privacy-sensitive parameters within the model as described in FedML-HE: An Efficient Homomorphic-Encryption-Based Privacy-Preserving Federated Learning System, arXiv: 2303.10837 [cs.LG] Oct. 30, 2023.

Developing privacy enhancements for FL is a continuing research thread. Elkordy, et al. produced a paper in 2022 outlining the theoretical bounds for information leakage and its relationship with the number of clients participating. See, Elkordy, et al., How Much Privacy Does Federated Learning with Secure Aggregation Guarantee? arXiv: 2208.02304v1 [cs.LG] 3 Aug. 2022. And in 2022, Sébert, et al. explored combining homomorphic encryption with differential privacy for protecting FL training data in Combining FHE and DP in Federated Learning, arXiv: 2205.04330v2 [cs.CR] 31 May 2022. But these privacy solutions all require performance trade-offs.

The following patents and published applications also describe various other methods that have been implemented in the prior art to secure data during the federated learning (“FL”) process. U.S. Patent Pub. No. US20210143987 describes key distribution in an FL setting; U.S. Patent Pub. No. Patent US20220374544 describes applying SMPC (secure multi-party computation) to an FL system; U.S. Pat. No. 11,188,791 describes creating an anonymized training set on the client before even training the client model; U.S. Patent Pub. No. US20210166157 describes privatizing the clients' model updates (because the server can perform a diff between the previous global model and a given current client model) and U.S. Pat. No. 11,139,961 describes the use of homomorphic encryption (within the context of a single system). Each of these methods requires a performance trade-off.

Accordingly, there is a need in the art for an architecture and process which preserves data privacy throughout the process without trading off performance.

### SUMMARY OF EMBODIMENTS

In a first embodiment, a process for securing individual client data during federated learning of a global model, includes: during a first global model training run:
i. receiving, by a first client, a request from a central server, for one or more individual segments of a first client's model trained on first client data;
ii. generating, by a key distributor, a first public-private key pair for the first global model training run and providing a first public key to the first client;
iii. homomorphically encrypting, by the first client, each of the one or more individual segments of the first client's model using the first public key;
iv. providing, by the first client, responsive to the request, the encrypted one or more individual segments of the first client's model and the first public key to the server;
v. receiving, by a second client, the request from a central server, for one or more individual segments of a second client's model trained on second client data;
vi. providing, by the key distributor, the first public key to the second client;
vii. homomorphically encrypting, by the second client, each of the one or more individual segments of the second client's model using the first public key;
viii. providing, by the second client, responsive to the request, the encrypted one or more individual segments of the second client's model and the first public key to the server;
ix. aggregating, by the server, the encrypted one or more individual segments of the first and second clients' models to generate an updated first global model;
x. notifying, by the server, the key distributor to provide the private key from the first public-private key pair to requesting clients;
xi. pushing, by the server, the updated first global model to the first and second clients;
training the updated first global model on the first and second data at the first and second clients; and repeating steps i. to xi. for at least one additional global model training run until a final global model meeting at least one predetermined criteria is generated by the server.

In a second embodiment, a process for securing individual client data during federated learning of a global model, includes: determining, by a server, initial parameters W for an untrained global model; selecting, by the server, at least two clients, cᵢ, and providing the untrained global model thereto, wherein each of the at least two clients cᵢ initializes its individual model, mᵢ, with W and trains mᵢ over data Dᵢ to produce its own new parameters, wᵢ, for the global model, wherein each mᵢ includes at least one parameter matrix M; initiating, by the server, generation of a public-private key pair by a key distributor, wherein the key distributor provides the public key to the at least two clients, cᵢ; determining, by the server, a number Nᵢ of parameter matrices M of each individual model, mᵢ, that each client cᵢ should provide to the server;
receiving, by the server, Nᵢ parameter matrices from clients cᵢ, wherein the Nᵢ parameter matrices M are homomorphically encrypted by the at least two clients, cᵢ; using the public key;
aggregating, by the server, the encrypted Nᵢ parameter matrices M to generate an updated global model; notifying, by the server, the key distributor to provide the private key from the public-private key pair to clients, cᵢ; and pushing, by the server, the updated global model to the clients, cᵢ.

In a third embodiment, a non-transitory computer readable medium stores instructions for securing individual client data during federated learning of a global model, the instructions including: determining, by a server, initial parameters W for an untrained global model; selecting, by the server, at least two clients, cᵢ, and providing the untrained global model thereto, wherein each of the at least two clients cᵢ initializes its individual model, mᵢ, with W and trains mᵢ over data Dᵢ to produce its own new parameters, wᵢ, for the global model, wherein each mᵢ includes at least one parameter matrix M; initiating, by the server, generation of a public-private key pair by a key distributor, wherein the key distributor provides the public key to the at least two clients, cᵢ; determining, by the server, a number Nᵢ of parameter matrices M of each individual model, mᵢ, that each client cᵢ should provide to the server; receiving, by the server, Nᵢ parameter matrices from clients cᵢ, wherein the Nᵢ parameter matrices M are homomorphically encrypted by the at least two clients, cᵢ; using the public key; aggregating, by the server, the encrypted Nᵢ parameter matrices M to generate an updated global model; notifying, by the server, the key distributor to provide the private key from the public-private key pair to clients, cᵢ; and pushing, by the server, the updated global model to the clients, cᵢ.

### BRIEF DESCRIPTION OF THE DRAWINGS

The embodiments herein will be better understood from the following detailed description with reference to the drawings, in which:

FIG. 1 is a schematic of a prior art federated learning system;

FIG. 2 is a schematic of a federated learning system incorporating client model segmentation (CMS) and full homomorphic encryption (FHE) in accordance with the embodiments herein;

FIGS. 3a (MNIST) and 3b (CIFAR-10) show how round-over-round performance is affected by changing the number of clients in the federation in accordance with the embodiments herein;

FIGS. 4a (MNIST) and 4b (CIFAR-10) show how round-over-round performance is affected by changing the number of client parameter matrices collected per each global model parameter matrix for aggregation in accordance with the embodiments herein; and

FIGS. 5a (MNIST) and 5b (CIFAR-10) show the round-over-round performance against server-side processing time for four different run types of the simulation in accordance with the embodiments herein.

### DETAILED DESCRIPTION

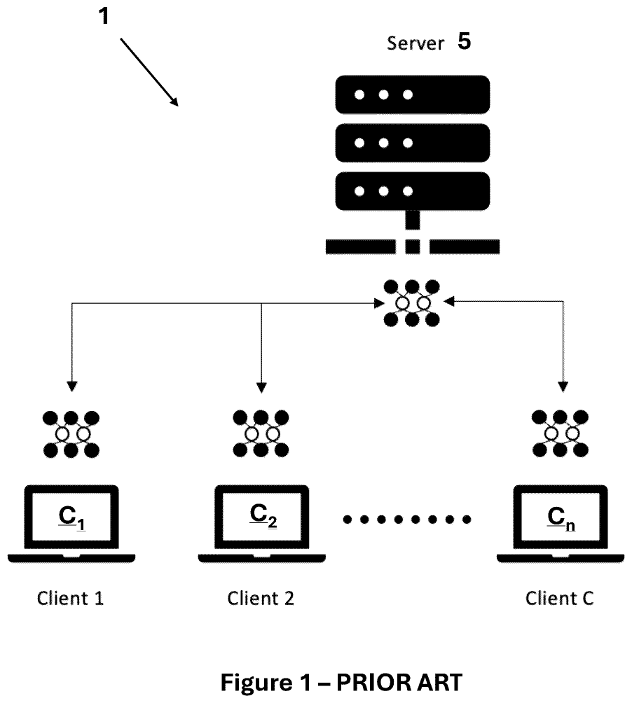

Initially, FIG. 1 provides a basic diagram of the standard FL system 1 and process flow which includes clients (C₁, C₂ . . . Cₙ) and server 5. Federated learning allows multiple data owners to train models such that each data owner's data remains siloed. Centralized FL uses a one-to-many server-client architecture, with C>1 clients (i.e., data owners) and 1 central server orchestrating the clients (i.e., the federation). Each client cᵢ contains a local model with parameter matrices wᵢ that can be trained based upon observations dⱼ∈Dᵢ.

In the typical training scheme, as displayed in FIG. 1, the server creates an untrained model and sends the model's parameters, W, to all clients within the federation. Then cᵢ initializes its model with W and trains over Dᵢ to produce its own new parameters, wᵢ. Each cᵢ then sends the trained wᵢ, along with the size of its training set tᵢ=|Dᵢ|, to the server, and the server carries out the following aggregation procedure:

$${W}_{n e w} = \frac{{\sum }_{i = 1}^{C} {w}_{i} {t}_{i}}{{\sum }_{i = 1}^{C} {t}_{i}}$$

W_{new} is then sent to all clients, and this concludes the first round of FL. Successive rounds may be conducted to produce improved models. The primary privacy-preserving feature of FL is that each client gets the benefit of a model trained on every client's data without having to reveal its raw data either to any other client or to the central server.

There is a flaw in the privacy-preserving protections offered using standard FL. The privacy of FL is provided by the protocol's ability to prevent client data from leaving the edge device. However, sending full, plaintext models to the server poses a serious risk: the server could reverse engineer the model to potentially reveal sensitive characteristics of the data, such as PII, used to train client models. This risk is well-researched as described in Lyu, et al., Threats to Federated Learning: A Survey, arXiv: 2003.02133v1 [cs.CR] 4 Mar. 2020. Thus, to maximize the security of an FL system, this risk of server-side model inversion attacks should be addressed. Similarly, in cases where a semi-honest adversary A has white-box access to either the server or a client within the federation. A will respect the federated learning protocol of the standard FL process, but A will also try to learn from models to assess the data client cᵢ might contain. Accordingly, a privacy threat can emerge in two different ways: (1) A is able to access the server and obtain the global model or (2) A is able to access a client and obtain the global model upon the completion of a round of FL. In either case, with access to a global model, a model inversion attack could be performed.

While theoretically, the application of homomorphic encryption alone would solve the problem described herein, this isn't practical. Today's implementations of FHE are simply too time and space-intensive to be practical for our purposes. Homomorphically encrypting large weight matrices takes a considerable amount of time, and the result of that encryption requires many gigabytes of space. A description of FHE can be found in Park et al., Privacy-Preserving Federated Learning Using Homomorphic Encryption. Appl. Sci. 2022, 12, 734.

Client model segmentation (CMS), on the other hand, does not fully protect against this problematic reverse engineering attack. Over time, the server may receive enough segments from a given client to piece together an approximation of that client's full model. A description of a segmented FL approach can be found on-line in Hu et al., Decentralized Federated Learning: A Segmented Gossip Approach, arXiv: 1908.07782v1 [cs.LG] 21 Aug. 2019.

The key differentiator in the embodiments herein, then, is our use of CMS to share only small portions of the model while also maintaining the strict security of FHE over the complete segment transferred from client to server. This lowers bandwidth requirements substantially over vanilla combinations of FL with FHE while still providing complete encryption and maintaining model accuracy.

The embodiments described herein address both threat scenarios. We guarantee that at no point is a complete model from a given client is shared with or seen by the central server or any other client within the federation. We also ensure that the resultant model sent to clients cannot be attacked to reconstruct other clients' datasets.

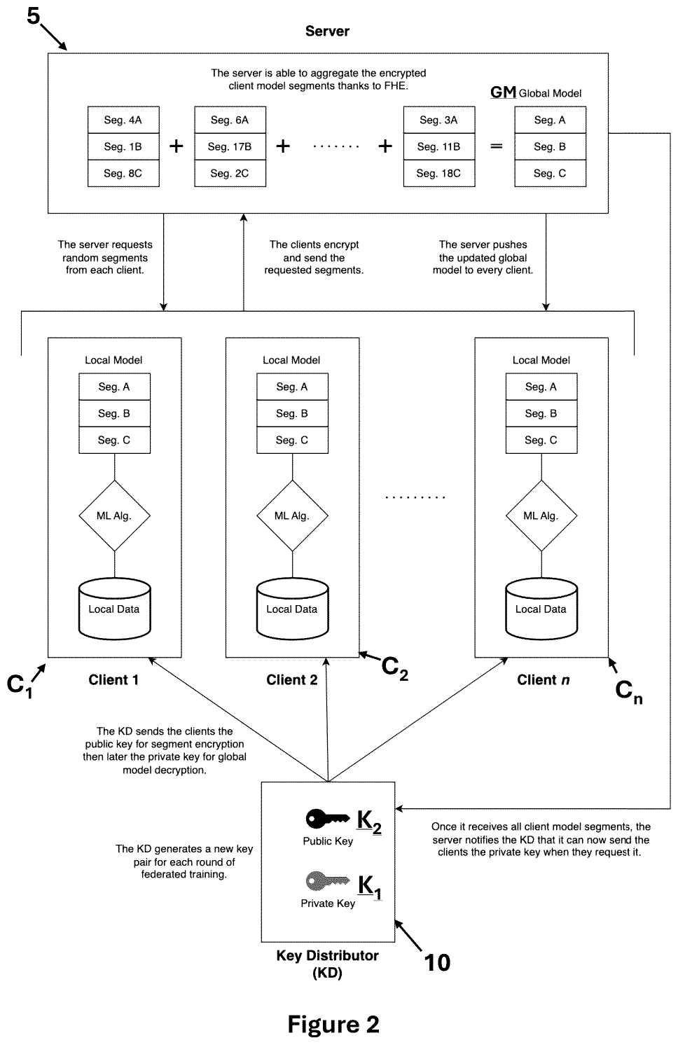

Our solution to the central server trust/security problem identified above incorporates two methods into the federated learning (FL) process: (1) client model segmentation (CMS): instead of each client sending its full model, the server only requests certain parameter matrices from each client model; and (2) fully homomorphic encryption (FHE): Client model segments are homomorphically encrypted before being sent to the server. FHE enables computations to be run on encrypted data, so the server is still able to aggregate received segments. FHE solves the server-side problem proposed and CMS reduces the high time and space requirements of FHE. We refer to our process as BlindFL. FIG. 2 provides an overview BlindFL.

As with prior art standard FL systems, the embodiments described herein uses client data D₁, D₂, . . . . Dₙ on each client C₁, C₂ . . . . Cₙ to generate an individual client model M₁, M₂ . . . . Mₙ. The central server 5 then requests a subset of each client's model layers or portion of a model layer(s), i.e., client model segments, e.g., Seg. 1B is Seg. B of client C₁. These client model segments are then subject to homomorphic encryption using a public key K₁ received from a key distributor 10 to encrypt each model layer or portion of model layer (segment) that the clients are sending to the server 5. The encrypted segments are pulled into the centralized server 5 and aggregated, all while maintaining the encryption of the weights, i.e., FHE enables computations to be run on encrypted data, so the server is still able to perform a weighted average of received segments. The updated, encrypted global model GM is then returned to the clients for decryption using the private key K₂ received from a key distributor 10. The individual segments from each client are thus never seen by the centralized server 10. A more detailed description is provided below.

Suppose that there is 1 server and C>2 clients, each of which has 1 model. Suppose that each model is a deep neural network (DNN) with M>0 parameter matrices. The server selects c≤C clients. The server then generates c random sequences of M booleans (each represented as a 0 or 1), which we represent as request matrix R of size c×M. The server generates R such that the following property holds true:

$${\sum }_{i = 1}^{c} {R}_{i , j} \geq p , ∀ j = 1 , 2 , … , M$$

where p is the number of client parameter matrices that must be gathered for each server-side global parameter matrix (i.e., p dictates how much of each client model is sent back to the server). The value p≥1 is configured before BlindFL begins. Further, since each element of R is either 0 or 1, it is clear that p≤c.

To generate R such that the above property holds true, the server calculates the number of matrices each client should send back, defined by N below:

$$N = ⌈ \frac{M \times p}{c} ⌉$$

The server then generates the c sequences of M booleans. For the first selected client, the server generates a sequence, R₁, of M booleans where N random booleans are set to 1. For the second selected client through the last selected client, the server initializes a sequence, Rᵢ, of M booleans all set to 0. It then calculates the sum of all previously generated Rᵢ sequences in the form of an M-length sequence where each value in the sequence denotes how many client parameter matrices will currently be requested for that given global model parameter matrix. Then, N times, the minimum value in that summations sequence is found, and a random index that has that minimum value is selected. A “true” boolean (a 1) is inserted at that index into Rᵢ. As 1's are inserted, the summations sequence is updated. The generation of these matrix requests is formalized in Algorithm 1.

The server then sends to each client the row of the matrix that corresponds to it (i.e., R₁ is sent to client 1, R₂ to client 2, and so on through R_{c}). For each i=1, 2, . . . , c, where R_{i,j}=1 for any j=1, 2, . . . , M, client i will send the server its j^{th} parameter matrix, w_{i,j}, as well as the number of examples that were used to train its model, t_{i,j}. Where R_{i,j}=0 for any j=1, 2, . . . , M, client i will set and send both w_{i,j} and t_{i,j} as 0. Once the server has received all requested w parameter matrices and t training example counts, it creates the global model using the following formula to calculate each aggregated parameter matrix Wⱼ:

$${W}_{j} = \frac{{\sum }_{i = 1}^{c} {w}_{i , j} {t}_{i , j}}{{\sum }_{i = 1}^{c} {t}_{i , j}} , ∀ j = 1 , 2 , … , M$$

All parameter matrices Wⱼ are then sent from the server to all C clients, thus placing the newly updated global model on each client. This method was implemented using the free and open-source “Flower: A Friendly Federated Learning Research Framework” as described in the on-line publication at arXiv: 2007.14390v5 [cs.LG] Mar. 5, 2022.

Algorithm 1 Request Matrix Generation

```
  1: procedure GENERATE-REQUEST-MATRIX(M, c, P)
  $2 : N = ⌈ \frac{M \times ρ}{c} ⌉$
  3:  R ← array of c arrays of M 0’s
  4:  R₁ ← shuffled array of N 1’s and (M - N) 0’s
  S:  for i ← 2 to c do
  6:  sums ← array of M 0’s
  7:  for j ← 1 to c do
  8:  for k ← 1 to M do
  9:  sumsₖ = sumsₖ + R_{j,k}
10:  end for
11:  end for
12:  for j ← 1 to N do
13:  min-value-indices = {}
14:  for k ← 1 to M do
15:  if sumsₖ min(sums) then
16:  min-value-indices += k
17:  end if
18:  end for
19:  rand-min-index = random(min-value-indices)
20:  R_{i,rand-min-index} = 1
21:  sums_{rand-min-index} + = 1
22:  end for
23:  end for
24  return R
25: end procedure
```

BlindFL leverages asymmetric FHE, which requires two keys: a public key and a private key. The public key contains the information required to perform encryptions and encodings. As a result, the public key can be given to any system performing mathematical operations on the FHE values. However, the public key lacks the information to decrypt any encrypted values. For any party to be able to decrypt the model, it needs the private key.

BlindFL incorporates FHE into the CMS process described above at the following points: (1) the client homomorphically encrypts the requested parameter matrices and example counts per segment before sending them to the server; (2) the server uses homomorphic operations to perform an encrypted, weighted average of the corresponding client model segments; and (3) the server sends the complete, encrypted updated model to the clients, and the clients decrypt using the private key.

These two steps require that FHE keys be properly distributed to maximally preserve privacy. We introduce a third node type, a key distributor (KD), to address this need. The KD is incorporated as follows:
1. The KD generates both public and private FHE keys.
2. The KD sends the public key (with its associated FHE context) to each client node.
3. Each client node performs its necessary encryption and sends the result and the public key (with the FHE context) to the server.
4. The server performs the aggregation homomorphically, pushes the updated global model to each client node, and notifies the KD that the clients are now ready to receive the private key. Note that the server notifies the KD as opposed to a client. This is so that only one party has to be trusted to truthfully attest to the completion of the global model.
5. The KD sends the private key to each client.
6. The client decrypts the updated global model.
7. A round of training is now complete, and the process starts over.

The KD generates a new key pair for each round of training. Otherwise, a valid private key would carry over from the previous round of training, increasing the ability of clients to intercept and decrypt the other clients' models in transit. For exemplary purposes, this process is implemented using the free and open-source “Pyfhel: PYthon For Homomorphic Encryption Libraries” as described in the paper published at WAHC ′21, Nov. 15, 2021, Virtual Event, Republic of Korea.

In a real-world deployment, we would encrypt client-to-server communication via a Diffie-Hellman key exchange protocol. If layers being sent from the client to server were not encrypted, then the KD node could easily perform a man-in-the-middle (MITM) attack, recovering client layers and decrypting them using the private key. The same is also done for all communication sent from the KD node.

Finally, as another necessary step for real-world deployment, each node in the federation would need to be equipped with a certificate for verifying identity.

The unique advantage of BlindFL is found in its hybridization of FHE and CMS. Hybridizing these components enables FHE to be used in contexts that it would otherwise be too time- and space-intensive. Without CMS, FHE would fully protect against the server-side privacy risks of FL. However, current-day FHE has very high time and space requirements. As a result, it is often impractical to encrypt and send entire models from every client in a federation. In such cases, BlindFL can be implemented to provide the enhanced security of FHE while also decreasing its time and space requirements.

CMS, on the other hand, does not fully protect against a model inversion attack. By piecing together segments from a given client collected round-over-round, the server can potentially approximate a full model from a client. However, CMS significantly reduces the load of FHE on any given client. As a result, CMS enables the performance gains that BlindFL offers relative to traditional FHE implementations.

BlindFL experiments were run via simulation. The following parameters were set for each run of the simulation: (1) Number of clients—The dataset for a given experiment is randomly shuffled, then evenly partitioned among the clients; (2) Number of client parameter matrices selected per global model parameter matrix—When this parameter is equal to the number of clients, CMS is effectively inactive; (3) Number of rounds of federated learning; and (4) Whether or not FHE should be active—And parameters for the FHE context are set (see below for additional description of FHE context selection).

For each experiment described below, one or more of these parameters is varied. Each result is averaged across 5 runs of the experiment. The experiments were run on two use cases: classification on the MNIST dataset using a LeNet-5 model and classification on the CIFAR-10 dataset using a ResNet20 model. The datasets were partitioned evenly amongst the given number of clients for a given run of the simulation (e.g., for a run with 3 clients, each client is given a third of the dataset). The LeNet-5 model has 10 total parameter matrices, and the ResNet20 model has 20 total parameter matrices.

All experiments were run on an AWS EC2 r5.8xlarge instance, which has a vCPU count of 32 and 256 GiB of memory. These high specifications allowed simulations of the system to run many clients at once on a single instance, which is an intensive process due to the FHE involved. The accuracy recorded in the figures below is measured as the average accuracy of the global model across each client's test set. As previously described, Flower was used for our federated learning implementation, and Pyfhel was used for our fully homomorphic encryption implementation.

Before any other experiments were run, simulations with FHE enabled and CMS inactive were tried to determine the smallest FHE context required to (a) successfully run BlindFL without crashing and (b) maintain the accuracy of the model. The FHE framework, Pyfhel, required that the following parameters be determined: the n value, the scale, and the qi sizes. Powers of 2 were tested for the n value. Only 2¹⁴ and 2¹⁵ allowed the simulation to run without error, and 2¹⁵ caused the simulation to run over 4 times slower. Thus, 2¹⁴ was selected. Powers of 2 were also tested for the scale. The minimum scale that still allowed the simulation to run without error, 2³⁰, was selected. Finally, it was determined that at least 4 qi size values were required, and the following were the smallest functional qi sizes tested: [40, 30, 30, 40]. In summary, our Pyfhel FHE context had the following settings:
Scheme: CKKS
n: 2¹⁴
Scale: 2³⁰
Qi Sizes: [40, 30, 30, 40]
   This context is used for all experiments described below.

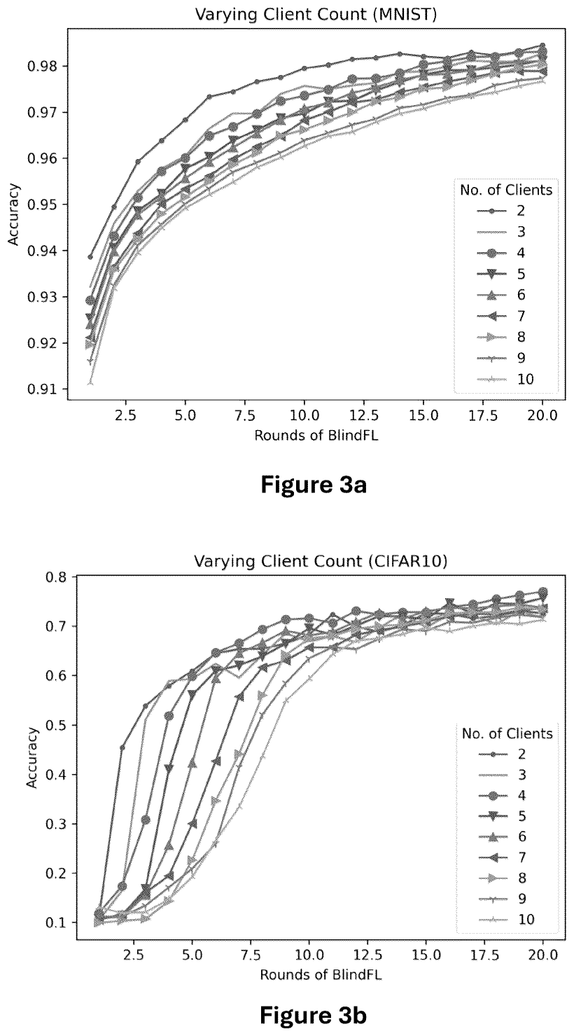

FIGS. 3a (MNIST) and 3b (CIFAR-10) show, for both of our use cases, how round-over-round performance is affected by changing the number of clients in the federation. Performance is measured as the average accuracy of the aggregated global model on each client's test data. This experiment was run with both the CMS and FHE components active, with CMS selecting a number of client parameter matrices per global model parameter matrix equal to half the number of clients.

Notice the very slight decrease in performance as the number of clients is increased. As previously mentioned, for a given experiment, the original, full dataset (whether MNIST or CIFAR-10) is partitioned evenly among the number of clients. The very slight decrease in performance, then, is simply an artifact of each client having a bit less data to train with. Overall, though, this result makes clear that, as long as the overall training set remains the same, the number of clients in a BlindFL federation has little to no effect on model performance.

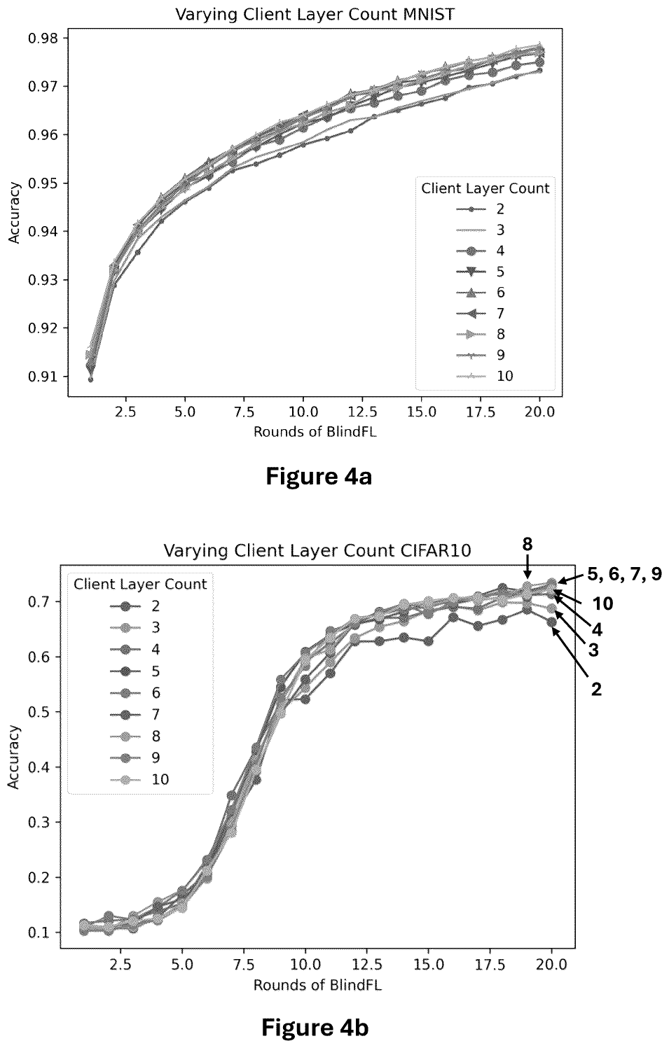

FIGS. 4a (MNIST) and 4b (CIFAR-10) show, for both of our use cases, how round-over-round performance is affected by changing the number of client parameter matrices collected per each global model parameter matrix for aggregation. All runs of the simulation for this experiment had 10 total clients, and the FHE component was active.

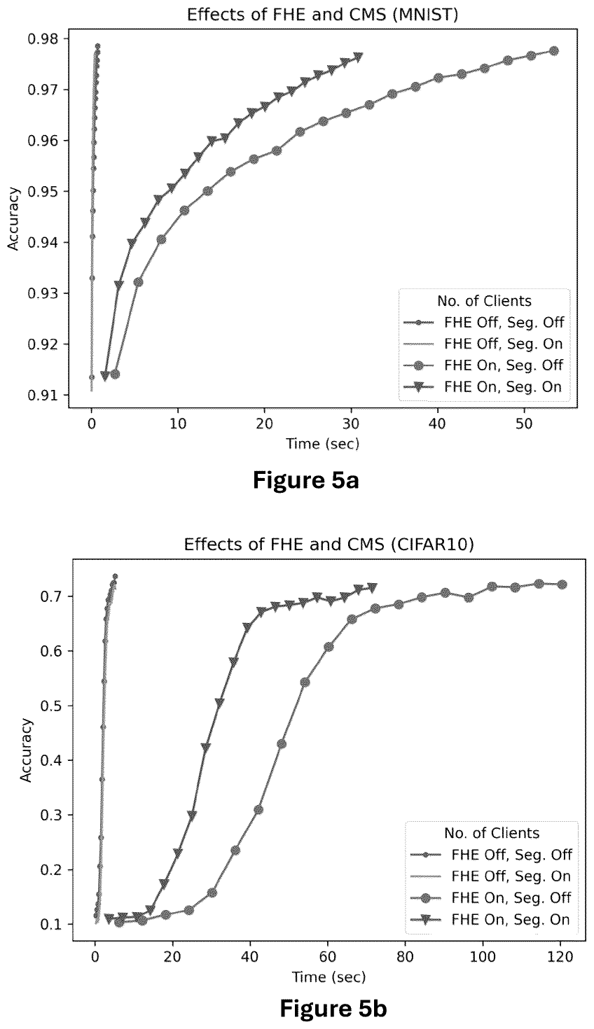

FIGS. 5a (MNIST) and 5b (CIFAR-10) show, for both of our use cases, the round-over-round performance against server-side processing time for four different run types of the simulation: Run 1—Without FHE and without CMS; Run 2—With FHE and without CMS; Run 3—Without FHE and with CMS (with 5 client parameter matrices per global model parameter matrix); and Run 4—With FHE and with CMS (with 5 client parameter matrices per global model parameter matrix). The number of clients for these runs was set to 10. Also, each shape along the lines in FIGS. 5a and 5b represents one round of BlindFL.

Over the course of 20 rounds of federated learning, we see that the same level of accuracy is achieved across all four run types. In other words, while FHE introduces a clear time overhead, neither component of BlindFL impacts the level of accuracy that is converged to. This is an especially notable result given the introduction of CMS-segmentation does not result in any decrease in convergence accuracy. Overall, it may be concluded that BlindFL does not negatively impact the accuracy of models.

Furthermore, FHE's time overhead is very effectively reduced by CMS. As previously mentioned, this experiment includes 10 clients, and by requesting only 5 parameter matrices from each client, we are able to cut server-side processing time in half. This 50% time reduction can even be further reduced by requesting even fewer parameter matrices from clients, which per the experiment detailed in section 6.3, will not result in reduced accuracy.

Tables 1 and 2 show, for both of our use cases, the average amount of data sent to the server per client, varying the number of client parameter matrices CMS sends and setting FHE both on and off. For these experiments, 10 clients were used.

TABLE 1
Amount of Data Sent per Client (MNIST)

| | | |
|---|---|---|
| Client Param. | | |
| Matrices | Without FHE | With FHE |

| | | | | |
|---|---|---|---|---|
| 1 | 21 | KB | 217 | KB |
| 2 | 43 | KB | 409 | KB |
| 3 | 65 | KB | 575 | KB |
| 4 | 87 | KB | 699 | KB |
| 5 | 109 | KB | 802 | KB |
| 6 | 109 | KB | 836 | KB |
| 7 | 152 | KB | 932 | KB |
| 8 | 154 | KB | 969 | KB |
| 9 | 174 | KB | 1010 | KB |
| 10 | 218 | KB | 1048 | KB |

TABLE 2
Amount of Data Sent per Client (CIFAR-10)

| | | |
|---|---|---|
| Client Param. | | |
| Matrices | Without FHE | With FHE |

| | | | | |
|---|---|---|---|---|
| 1 | <1 | KB | 126 | KB |
| 2 | 1 | KB | 246 | KB |
| 3 | 2 | KB | 361 | KB |
| 4 | 3 | KB | 467 | KB |
| 5 | 4 | KB | 574 | KB |
| 6 | 5 | KB | 646 | KB |
| 7 | 5 | KB | 747 | KB |
| 8 | 6 | KB | 805 | KB |
| 9 | 7 | KB | 872 | KB |
| 10 | 9 | KB | 1048 | KB |

It is clear that, while FHE does introduce a high space overhead, this overhead still results in very manageable client-server bandwidth requirements. Furthermore, as with FHE's time overhead, CMS cuts done FHE's space overhead significantly.

Federated learning is a useful technique for preserving the privacy of distributed data used to train ML models. However, the threat to privacy posed by inversion attacks is significant. While many different PPFL techniques have been proposed, each comes with its own inherent risks and flaws. A technology shown to be very effective at protecting data against these attacks is FHE. FHE greatly reduces the ability of a server to perform an inversion attack, but it does have several drawbacks: increased requirements of compute, memory, network traffic, and time. These drawbacks make FHE less ideal for systems with high volume, low compute, or even low bandwidth, such as edge systems.

Our proposed solution, BlindFL, is a scalable PPFL that enhances an FHE approach with client model segmentation (CMS). Unlike FHE, CMS by itself does not fully protect against server-side inversion attacks, but it does provide increased privacy. Furthermore, it significantly reduces the demands of FHE on both the clients and the server. We are thus able to implement BLindFL in contexts that an FHE-only approach would be too slow or data-intensive.

Our solution also maintains the accuracy of the aggregated global model and displays great performance overall. The addition of CMS cuts server-side process time roughly in half. Furthermore, in contexts such as edge computing, bandwidth requirements can be a significant limitation. While our experiments show an increase in client-server bandwidth requirements due to FHE, CMS greatly reduces those requirements, thus providing higher security for only a mild increase in bandwidth. Additionally, BlindFL maintains practically identical accuracy to non-FHE models on both the MNIST and CIFAR-10 datasets. Thanks to all the enhancements it offers, BlindFL can be confidently offered as a solution for enhanced FL privacy, even for applications that FHE would typically be impractical for.

BlindFL protects the security of client data during the federated learning including, but not limited to personal health information, personal financial information, personal identifying information, and asset location information. Exemplary use cases for BlindFL might include, but are not limited to: health diagnosis systems, wherein healthcare providers can collaborate to produce a model that gives more accurate patient diagnoses without revealing patient data to one another; inter-intelligence agency collaboration, wherein agencies like the FBI, CIA, and DIA could all collaborate to produce models that more accurately flag threats; autonomously piloted assets such as aircraft, ships, vehicle, wherein self-piloting assets could collaborate to produce a model that is piloted more safely and efficiently; mobile applications, e.g., next word prediction, face detection, voice recognition, without revealing personal information; and protecting against financial fraud, e.g., with BlindFL, financial institutions across the globe can collaborate to improve fraud detection, and stop more fraudulent transactions before they occur, without revealing customers' personal information.

All references and patent documents cited in this disclosure are incorporated herein by reference in their entireties.

We claim:

1. A process for securing individual client data during federated learning of a global model, the process comprising:
during a first global model training run:
i. receiving, by a first client, a request from a central server, for one or more individual segments of a first client's model trained on first client data;
ii. generating, by a key distributor, a first public-private key pair for the first global model training run and providing a first public key to the first client;
iii. homomorphically encrypting, by the first client, each of the one or more individual segments of the first client's model using the first public key;
iv. providing, by the first client, responsive to the request, the encrypted one or more individual segments of the first client's model and the first public key to the server;
v. receiving, by a second client, the request from a central server, for one or more individual segments of a second client's model trained on second client data;
vi. providing, by the key distributor, the first public key to the second client;
vii. homomorphically encrypting, by the second client, each of the one or more individual segments of the second client's model using the first public key;
viii. providing, by the second client, responsive to the request, the encrypted one or more individual segments of the second client's model and the first public key to the server;
ix. aggregating, by the server, the encrypted one or more individual segments of the first and second clients' models to generate an updated first global model;
x. notifying, by the server, the key distributor to provide the private key from the first public-private key pair to requesting clients;
xi. pushing, by the server, the updated first global model to the first and second clients;
training the updated first global model on the first and second data at the first and second clients; and
repeating steps i. to xi. for at least one additional global model training run until a final global model meeting at least one predetermined criteria is generated by the server.

2. The process of claim 1, wherein, prior to first training on first and second clients' data, initial parameters W for an untrained model are determined by the server and provided to the first and second clients, cᵢ, wherein i=1 for the first client and i=2 for the first client; and further wherein each client cᵢ initializes its model with W and trains over data Dᵢ to produce its own new parameters, wᵢ.

3. The process of claim 2, wherein the aggregating, by the server, the encrypted one or more individual segments of the first and second clients' models is performed in accordance with the following procedure:
$${W}_{new} = \frac{{\sum }_{i = 1}^{C} {w}_{i} {t}_{i}}{{\sum }_{i = 1}^{C} {t}_{i}}$$
wherein each cᵢ sends its trained wᵢ, along with a size of its training data set tᵢ=|Dᵢ| to the server in advance thereof.

4. The process of claim 3, wherein the one or more individual segments of the first and second clients' models are parameter matrices M.

5. The process of claim 4, wherein for each of the first and second clients, the server calculates a number of parameter matrices each client should send back to the server to generate a global model parameter matrix, and further wherein, when the server has received all requested wᵢ parameter matrices and tᵢ training example counts, the server creates the global model using the following formula to calculate each aggregated parameter matrix Wⱼ:
$${W}_{j} = \frac{{\sum }_{i = 1}^{c} {w}_{i , j} {t}_{i , j}}{{\sum }_{i = 1}^{c} {t}_{i , j}} , ∀ j = 1 , 2 , … , M .$$

6. The process of claim 4, wherein the first and second client models are deep neural network (DNN) with M>0 parameter matrices.

7. The process of claim 1, wherein the client data is selected from the group consisting of personal health information, personal financial information, personal identifying information, and asset location information.

8. A process for securing individual client data during federated learning of a global model, the process comprising:
determining, by a server, initial parameters W for an untrained global model;
selecting, by the server, at least two clients, cᵢ, and providing the untrained global model thereto, wherein each of the at least two clients cᵢ initializes its individual model, mᵢ, with W and trains mᵢ over data Dᵢ to produce its own new parameters, wᵢ, for the global model, wherein each mᵢ includes at least one parameter matrix M;
initiating, by the server, generation of a public-private key pair by a key distributor, wherein the key distributor provides the public key to the at least two clients, cᵢ;
determining, by the server, a number Nᵢ of parameter matrices M of each individual model, mᵢ, that each client cᵢ should provide to the server;
receiving, by the server, Nᵢ parameter matrices from clients cᵢ, wherein the Nᵢ parameter matrices M are homomorphically encrypted by the at least two clients, cᵢ; using the public key;
aggregating, by the server, the encrypted Nᵢ parameter matrices M to generate an updated global model;
notifying, by the server, the key distributor to provide the private key from the public-private key pair to clients, cᵢ; and
pushing, by the server, the updated global model to the clients, cᵢ.

9. The process of claim 8, wherein the aggregating, by the server, the encrypted Nᵢ parameter matrices M from clients cᵢ is performed in accordance with the following procedure:
$${W}_{n e w} = \frac{{\sum }_{i = 1}^{C} {w}_{i} {t}_{i}}{{\sum }_{i = 1}^{C} {t}_{i}}$$
wherein each cᵢ sends its trained wᵢ, along with a size of its training data set tᵢ=|Dᵢ| to the server in advance thereof.

10. The process of claim 9, wherein for each of the at least two clients cᵢ, the server calculates a number of parameter matrices each client cᵢ should send back to the server to generate a global model parameter matrix, and further wherein, when the server has received all requested wᵢ parameter matrices and tᵢ training example counts, the server creates the updated global model using the following formula to calculate each aggregated parameter matrix Wⱼ:
$${W}_{j} = \frac{{\sum }_{i = 1}^{c} {w}_{i , j} {t}_{i , j}}{{\sum }_{i = 1}^{c} {t}_{i , j}} , ∀ j = 1 , 2 , … , M .$$

11. The process of claim 10, wherein the individual models are deep neural network (DNN).

12. The process of claim 8, wherein the client data is selected from the group consisting of personal health information, personal financial information, personal identifying information, and asset location information.

13. A non-transitory computer readable medium storing instructions for securing individual client data during federated learning of a global model, the instructions comprising:
determining, by a server, initial parameters W for an untrained global model;
selecting, by the server, at least two clients, cᵢ, and providing the untrained global model thereto, wherein each of the at least two clients cᵢ initializes its individual model, mᵢ, with W and trains mᵢ over data Dᵢ to produce its own new parameters, wᵢ, for the global model, wherein each m; includes at least one parameter matrix M;
initiating, by the server, generation of a public-private key pair by a key distributor, wherein the key distributor provides the public key to the at least two clients, cᵢ;
determining, by the server, a number Nᵢ of parameter matrices M of each individual model, mᵢ, that each client cᵢ should provide to the server;
receiving, by the server, Nᵢ parameter matrices from clients cᵢ, wherein the Nᵢ parameter matrices M are homomorphically encrypted by the at least two clients, cᵢ; using the public key;
aggregating, by the server, the encrypted Nᵢ parameter matrices M to generate an updated global model;
notifying, by the server, the key distributor to provide the private key from the public-private key pair to clients, cᵢ; and
pushing, by the server, the updated global model to the clients, cᵢ.

14. The non-transitory computer readable medium of claim 13, wherein the aggregating, by the server, the encrypted Nᵢ parameter matrices M from clients cᵢ is performed in accordance with the following procedure:
$${W}_{n e w} = \frac{{\sum }_{i = 1}^{C} {w}_{i} {t}_{i}}{{\sum }_{i = 1}^{C} {t}_{i}}$$
wherein each cᵢ sends its trained wᵢ, along with a size of its training data set tᵢ=|Dᵢ| to the server in advance thereof.

15. The non-transitory computer readable medium of claim 14, for each of the at least two clients cᵢ, the server calculates a number of parameter matrices each client cᵢ should send back to the server to generate a global model parameter matrix, and further wherein, when the server has received all requested wᵢ parameter matrices and tᵢ training example counts, the server creates the updated global model using the following formula to calculate each aggregated parameter matrix Wⱼ:
$${W}_{j} = \frac{{\sum }_{i = 1}^{c} {w}_{i , j} {t}_{i , j}}{{\sum }_{i = 1}^{c} {t}_{i , j}} , ∀ j = 1 , 2 , … , M .$$

16. The non-transitory computer readable medium of claim 15, wherein the individual models are deep neural network (DNN).

17. The non-transitory computer readable medium of claim 13, wherein the client data is selected from the group consisting of personal health information, personal financial information, personal identifying information, and asset location information.
